(19) United States
(12) Patent Application Publication
(10) Pub. No.: US 2022/0103118 A1
(43) Pub. Date: Mar. 31, 2022

(54) Frame weep hole modified frames for earth-oriented solar panels

(71) Applicant: Erthos IP LLC, Tempe, AZ (US)

(72) Inventors: James Scott Tyler, Queen Creek, AZ (US); William Hammack, Taos, NM (US)

(21) Appl. No.: 17/377,362

(22) Filed: Sep. 30, 2021

Related U.S. Application Data
(60) Provisional application No. 63/052,369, filed on Jul. 15, 2020.

(51) Int. Cl. H02S 30/10; H02S 20/10

(52) U.S. Cl. CPC H02S 30/10; H02S 20/10

(57) ABSTRACT

Utility-scale photovoltaic panels or modules for flat-on-ground mounting or mounting without a support structure between the module and the ground that have been adapted by including air vents or weep hole in a portion of the module frame. In operation, the vent holes allow air under the modules to escape if the module array is exposed to flooding. Letting under-module air to move through the weep holes lowers the buoyancy of the modules to prevent flood exposure from floating the modules. Also, weep holes or air vents allow air pressure equalization between the top surface of the module and the region under the PV module such as low pressures generated by heavy wind passing across the face of the array.

### BACKGROUND

### Technical Field

The disclosed technology relates to the mounting of solar panels using a terrestrial or ground-based mounting system.

### Background Art

Solar panels or modules are assemblies of multiple photovoltaic (PV) cells hardwired to form a single unit, typically as a rigid piece. Flexible solar panels are known, as well. Multiple solar panels form an array with strings of panels wired together in series. These strings connect to a power receiving unit, typically an inverter or other controller, that provides an initial power output. One or more solar arrays form a solar plant.

A silicon-based PV module, also commonly called crystalline silicon (c-Si) PV module, is a packaged, connected assembly of typically 6×12 photovoltaic solar cells. But this can vary according to design choice. Other types of PV cell technology include “thin-film” and variations of silicon-based technology. Two thin-film module technologies stand out. The first is CdTe (Cadmium Tellurium), also known as CadTel. The second is CIGS or CIS (Copper, Indium, Gallium, Selenium or Copper, Indium, Selenium).

The number of panels making up a string can vary. Strings can contain 17-29 panels in typical applications depending on both the environmental condition and the module's rated voltage (string voltage). The row size of panels in a row of Single Axis Tracker (SAT) and Fixed Tilt (FT) systems can vary and a typical row is three (3) strings of 26-28 panels per row for SAT systems summing to between 76-84 panels per row. A single row is limited by geographical grade changes within the span of the row and rigid structural limitations based on the typical steel structure. Multiple rows of solar panels make up an array of solar panels. The array size is limited by power transmission limitations, including limiting maximum voltage and current at the Power Conversion Station and Medium Voltage Step Up Transformer. The panels within an array may be connected in one or more series or parallel strings. A series string is a set of panels series connected to increase voltage typically limited to 1500V DC per string for a Utility Scale Solar System. Arrays are often divided into multiple strings of equal voltage connected in parallel to sum the current. This arrangement limits the maximum voltage output of a string and the maximum current output of an array.

Thus, solar cells internally connect within a panel. And panels connect within a string. Multiple strings connect within a row. Multiple rows form an array that feeds into an inverter or inverters either directly or through wiring harnesses. Multiple inverters are connected to further output circuitry commonly MV Transformers, which are connected to transmission circuitry. The strings are connected either directly or through wiring harness connections to the inverter.

The goal is to reduce the Levelized cost of energy (LCOE) for the PV power plants. The utility-scale PV power plant is unique from the many other solar power and electricity production forms. Due to the size, energy cost, safety regulations, and operating requirements of utility-scale power production, the components, hardware design, construction means and methods, and operations and maintenance all have specific, unique features yielding the designation “utility-scale” typically at 1000V or 1500V DC generation sizing.

Since its inception, PV technology has been an expensive solution for power production. The PV cells within the heart of the solar modules have been very expensive to manufacture and inefficient. Over the past 40 years, significant strides have been made on PV cell and module manufacturing and technology fronts. These improvements have brought PV electricity costs below the more traditional utility-scale power generation methods in some geographical regions.

Today two main industry adopted technologies, Fixed Tilt (FT) racking and Single-Axis Tracking SAT, are commonly utilized as an industry standard structural means to securing the solar panels to orient them to the sun and optimize the solar panel efficiency and increase energy production to lower the cost of electricity of the solar system. Fixed Tilt racking and Single-Axis Trackers are rigid mounting systems, typically made of structural steel, and are expensive to install and maintain.

Fixed Tilt and Single-Axis Tracking methods are often categorized as “ground mount” technologies, which separates them from roof-mount technologies. “Ground Mount” means that the modules are supported by free-standing structures with dedicated foundations rather than buildings. Ground Mount technologies typically have the leading edge of the modules 1 ft or greater above finished grade and the high edge or trailing edge of the modules extending 10ft or greater above finished grade. Steel-pile reveal height for the structural racking is commonly 5 ft above grade with maximum and minimum being 3 ft-7 ft commonly depending on configuration. Typical row spacing for rows of solar panels is 15-21 ft due to the tilt angle of the modules and to prevent row to row shading.

When deployed in large solar farms, solar panels are typically mounted on racks that orient the panels toward the Sun. With gimballed racks, called trackers, the panel is pivoted to face the Sun throughout the day by tracking the sun, with some systems also accounting for solar elevation or otherwise account for the Sun's effect analemma. Fixed racking and tracking of PV modules increases efficiency of the solar modules by better aligning the modules to the sunlight through optimization of the solar incidence angle. Rows of FT or SAT plants are commonly spaced at 15-21 ft row spacing to avoid shading from row to row throughout the day.

Generally, the nature of solar cells is such that they are generally waterproof and durable. For example, it is common for solar modules to be tested and certified to withstand hail of up to 25 mm (one inch) falling at about 23 m/sec (51 mph). While it is possible to clean solar panels, as a practical matter, racked solar panels are not frequently cleaned because the expense is not justified by expected energy loss resulting from dirt and dust accumulation. For example, in Southern California, the estimated energy loss from dirt and dust is approximately 5%/year, but if the panels were cleaned, the loss would approximate 1%/year.

One consideration in mounting solar panels on racks or trackers is the albedo effect, resulting from sunlight reflecting from the ground, resulting in backside heating. This issue is addressed in various ways by coating the backside of the solar panels with a white coating. A disadvantage of doing that is that white coatings slow heat discharge through the module's backside. Today's industry is commonly now deploying bi-facial solar panels to extract additional energy from the solar panel in a FT or SAT configuration.

In typical configurations, the array output voltage (series voltage of the panels in a string) is 1500 volts. Solar arrays are limited in voltage due to solar panel manufacturing maximum voltage limits, the National Electric Code, and International Electric Code. To limit the voltage, panels are arranged in groups called strings that connect to the inverter through harnesses. The strings' physical arrangement on the trackers or racks requires harnessing equipment. In a typical tracker system, three sets of strings are used on a single tracker assembly. To connect those strings to the inverter, harnesses of varying configurations are used, although this number can change according to the rack's length and other considerations.

The harnesses themselves are a significant cost factor. Since the system is voltage-limited, the total power output of the plant translates to substantial wiring costs for harness systems. Similarly, power losses through the wiring harness translate to additional costs. Therefore, it is desired to provide a physical configuration of solar panels, rows, and arrays that reduces the length of cable runs in connection harnesses.

One wiring harness configuration used with racked modules is called “skip stringing” or “leapfrog wiring”. In skip stringing, wiring harnesses bypass alternate panels to provide efficient wiring by limiting cabling to approximately the distance between alternating modules. The ability to achieve connections extending over a longer distance without a proportional increase in cabling allows positive and negative connections to be placed closer to the inverter, reducing the number of harness conductors needed to connect to the inverter. Since the panels are alternately connected, the alternate panels within the same physical row can provide a return circuit, reducing the distance between an end panel and the inverter. Ideally, one positive or negative pole connection for connecting the string to the inverter is only one panel away from the other pole connection. This reduces the length of the “home run” wire but requires each link to skip alternate panels to return along the same row.

While it would be possible to string panels across two or more rows, it would shorten the rows and increase costs. Skip stringing wiring is used because, by skipping adjacent panels, the length of a string is maintained while providing for a return connection along the same row. This arrangement effectively doubles the length of a string over the length that would exist if the string were extended across two rows.

This stringing system accommodates the panels' polarities; however, this technique still requires wiring harnesses in the connection. In addition, these techniques still require additional harnesses to connect between the respective ends of the strings and the inverter. Since adjacent rows of panels are separated by a space corresponding to the cast shadow of racked panels, it becomes impractical to string panels across rows.

Another issue involving racked or tracker-mounted solar panels is the effect of wind. Dependent upon installation location, the wind speed can vary from 85-140 mph in the USA. High wind forces, which can reach hurricane force strength, often preclude the construction of solar power plants in those regions or increase the expense by requiring very robust structural steel with deep foundations and large cross-sectional areas for foundations as the mean wind force resisting system. In addition, the modules themselves are easily damaged by high winds requiring significant repair and replacement expenditures due to cyclic loading on the structure with the modules tilted like sails in the wind as they are fixed above finished grade. Besides apparent damage resulting from the direct forces of wind, the adverse effects of cyclic loading can cause “micro-cracking”. This “micro-cracking” damage occurs over time, causing accelerated degradation rates of the module cells. This micro-cracking has become a serious issue for the industry influencing long-term module warranties.

Another issue involving racked or tracker-mounted solar panels is environmental corrosion due to corrosive soils and corrosive air such as salt spray. Typical ground-mount power plants use driven steel piles sized to counter the effects of wind loading on the overall structure. Pile sizing is determined by geotechnical corrosion test results and structural loading requirements to resist wind loading for the area. Pile sizing must account for the corrosion of the steel or other materials and still be able to last for 25 years. The more corrosive the soil, the thicker the posts will be designed and used as sacrificial steel to ensure a 25-year life. Similar issues exist for geographies near the oceans where salt spray environments exist.

### BRIEF DESCRIPTION OF THE FIGURES

FIG. 1-a depicts a schematic view of a prior art PV module.

FIG. 2-a depicts a schematic view of a PV module according to this disclosure.

FIG. 3-AA depicts a cross-section of a PV frame.

FIG. 3-aB depicts a perspective view of a PV frame.

FIG. 4-aA depicts a front view of a PV frame.

FIG. 4-aB depicts a front view of a PV frame.

FIG. 5-a depicts a schematic view of a PV module according to this disclosure.

### DETAILED DESCRIPTION

Unless defined otherwise, all technical and scientific terms used in this document have the same meanings as commonly understood by one skilled in the art to which the disclosed invention pertains. Singular forms—a, an, and the—include plural referents unless the context indicates otherwise. Thus, reference to “fluid” refers to one or more fluids, such as two or more fluids, three or more fluids, etc. When an aspect is to include a list of components, the list is representative. If the component choice is limited explicitly to the list, the disclosure will say so. Listing components acknowledges that exemplars exist for each component and any combination of the components—including combinations that specifically exclude any one or any combination of the listed components. For example, “component A is chosen from A, B, or C” discloses exemplars with A, B, C, AB, AC, BC, and ABC. It also discloses (AB but not C), (AC but not B), and (BC but not A) as exemplars, for example. Combinations that one of ordinary skill in the art knows to be incompatible with each other or with the components' function in the invention are excluded, in some exemplars.

When an element or layer is called being “on”, “engaged to”, “connected to” or “coupled to” another element or layer, it may be directly on, engaged, connected, or coupled to the other element or layer, or intervening elements or layers may be present. When an element is called being “directly on”, “directly engaged to”, “directly connected to”, or “directly coupled to” another element or layer, there may be no intervening elements or layers present. Other words used to describe the relationship between elements should be interpreted in a like fashion (e.g., “between” versus “directly between”, “adjacent” versus “directly adjacent”, etc.).

Although the terms first, second, third, etc., may describe various elements, components, regions, layers, or sections, these elements, components, regions, layers, or sections should not be limited by these terms. These terms may distinguish only one element, component, region, layer, or section from another region, layer, or section. Terms such as “first”, “second”, and other numerical terms do not imply a sequence or order unless indicated by the context. Thus, a first element, component, region, layer, or section discussed below could be termed a second element, component, region, layer, or section without departing from this disclosure.

Spatially relative terms, such as “inner”, “outer”, “beneath”, “below”, “lower”, “above”, “upper” may be used for ease of description to describe one element or feature's relationship to another element or feature as illustrated in the figures. Spatially relative terms may be intended to encompass different orientations of the device in use or operation besides the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors interpreted.

The description of the exemplars has been provided for illustration and description. It is not intended to be exhaustive or to limit the invention. Individual elements or features of a particular exemplar are not limited to that exemplar but, where applicable, are interchangeable and can be used in a selected exemplar, even if not explicitly shown or described. The same may also be varied. Such variations are not a departure from the invention, and all such modifications are included within the invention's scope.

This application hereby incorporates by reference U.S. Provisional application Ser. No. 63/052,369 and U.S. Non-provisional application Ser. No. 17/316,535.

### TECHNOLOGY

The disclosed technology provides a technique for generating electricity using commercially available utility-scale PV (e.g., CSi, CdTe, CIGS, CIS) modules, new and novel adaptations of these modules, or new module technologies. A group of modules is mounted in direct contact and parallel with the Earth's surface. This mounting establishes an earth orientation of the PV modules, as distinguished from a solar orientation. But contouring of the soil and other mounting considerations will account for the Sun's angle, in some exemplars.

The modules are tiled into a grid pattern edge to edge and end to end. This technology does not limit how the modules attach to one another or to the Earth. This arrangement of modules substantially reduces the wind loading effects of the modules. The electrical arrangement of the modules allows for both series and parallel connections and eliminates, but does not preclude, the need for discrete wiring harnesses and harness supporting means used by traditional utility-scale solar plant PV power plant systems. This module arrangement provides significant advantages when used with string or microinverters but is equally suitable for industry-standard central inverters or alternate power conversion and transmission technologies.

Modules using prior art conductive module-support structures require module bonding and grounding to meet code.

This module arrangement dispenses with steel and steel structures in the power plant and their corrosion while increasing power plant life sometimes to greater than 40 years. But steel, coated or otherwise, may be used with these systems.

The arrangement of modules allows for both commercially available and new techniques for module cleaning and dust removal, increasing the effective energy production rate.

The module arrangement reduces high wind (sometimes hurricane strength) forces on the modules, which increases the cost of or often precludes construction of solar power plants in high-wind regions. Since high winds easily damage the modules, removing them from high winds reduces repair and replacement costs.

This technology allows for module cooling methods such as evaporative cooling, applying high emissivity coatings, adding “air vents” on module edges, adding heat transfer materials, or using heat transfer methods, increasing the modules' energy production rates. Ground positioning avoids module heating from indirect sunlight and sunlight-heated ground. This positioning transforms the ground from being a heat source to being a heat sink.

The disclosed technology increases the power density per acre of land. The quantity of acres used per unit of power production is reduced by over 50% from traditional utility-scale solar plant PV power plants. This technology eliminates row to row spacing as required to prevent shading of rows of modules.

Since the disclosed technology allows the PV array to follow existing land contours, the typical need for mass grading, plowing, tilling, cutting, and filling within arrays can be reduced or eliminated.

While not tracking the Sun reduces module performance, the overall cost savings from reduced electrical losses in wiring, removal of the structural steel racking system, energy increases from increase module cleaning, reduced material cost, and reduced construction schedule and risk costs yields a reduced produced energy price (LCOE) of greater than 10% over current technologies.

This adjacent positioning allows wiring connections or harnesses to take advantage of the adjacent relationships across two or more rows, reducing the need for harness connections. In a particular arrangement, module to module string connection distances, are reduced because adjacent rows can be connected without “skip stringing” or “leapfrog wiring”. DC Homerun connections commonly called “whips” are reduced due to the elimination of row-to-row spacing requirements. In an alternate arrangement, sequential connections can be made with “next” panels in adjacent rows, reducing the length of connections required for “skip stringing” or “leapfrog wiring”.

Eliminating structural racking affords an additional advantage with wire harnessing. Since there are no racks, there is no need to consider racks and associated wire management when designing wire harnesses. Thus, module strings can terminate at both ends of the strings close to the inverters. Multiple strings closely terminating allows inverter positioning close to string end terminations.

One concern with Earth Mount system installation is the behavior of the panel array when exposed to high winds. Of course, rack-mount systems experience trouble with winds and wind loading. But while mounting panels flat on the ground alleviates the most damaging wind effects on utility scale PV installations, panels flat on the ground are subject to high winds. In particular, array edges channel wind over the surface of the array. Air moving over the array surface could cause a drop in air pressure above the array. This type of transient air pressure reduction could cause the air pressure above the module to fall below that of air trapped underneath the module. This differential creates a net upward force on the modules—a type of buoyancy.

Panels flat on the ground are also subject to floodwaters or heavy runoff. This yields another type of buoyancy. Water over the modules with air trapped underneath the modules could cause the modules to float.

One way of dealing with both types of buoyancy is to vent the module so that air can freely move to equalize this air pressure differential. In some cases, the venting occurs through weep holes. These weep holes can be holes in the module side, holes in the face of the module, or other vents, such as a vent between the module substrate and module frame.

Flat-mounting panels on the ground results in substantially level module surfaces. Even so, each panel likely has a high point and the geometry of the module makes a high point likely near a corner of the module or perhaps along in edge. Air trapped by rising water will collect at the high point. Therefore, an operable location for a weep hole would be near a module corner or along a module edge. Similarly, a weep hole higher on the side of the module would be expected to function better than a weep hole lower on the side of the module.

Despite a corner being a likely high point, knowing which corner would end up higher would be difficult to determine before installation of the module. Therefore, having weep holes located near more than one corner would provide an advantage. For instance, a weep hole is located in each corner in some exemplars. In other exemplars, the module has two weep holes on the side, sometimes near the corner, sometimes two weep holes on two sides of the module, three sides of the module, or four sides of the module. Some examples have at least eight holes, which, in some cases are corner located to per corner.

Various versions have one or more fastening holes or slots penetrating the module sides. These fastening holes receive the components of a mesh cable system in versions of the array that used such a system for securing the module.

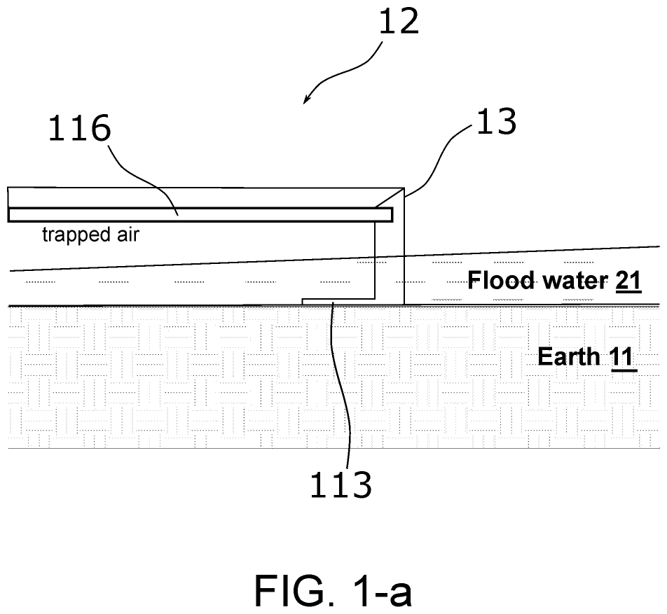

FIG. 1-a depicts a schematic view of a PV module 12 having module sides 13 connected to module base 113. PV module 12 has module substrate 116, which is the module component that generates electricity. Module 12 sits on Earth 11.

As depicted, floodwater 21 is shown rising up module side 13 such as may occur during a flood. As floodwater 21 rises, air is trapped underneath module 12, which can eventually float module 12.

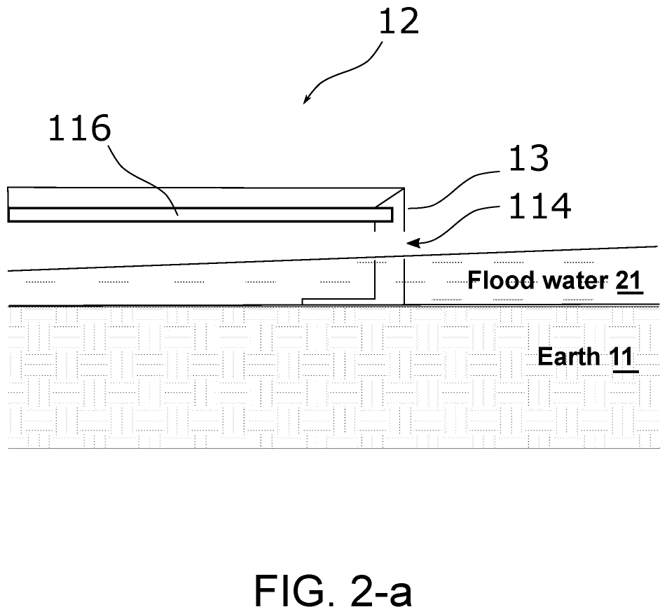

FIG. 2-a depicts module 12 with weep hole 114. Weep hole 114 allows air from underneath module 12 to escape, diminishing or preventing upward buoyant forces from raising module 12. Weep hole 114 is effective for flood-water-caused buoyancy and buoyancy caused by air flowing across the face of the array.

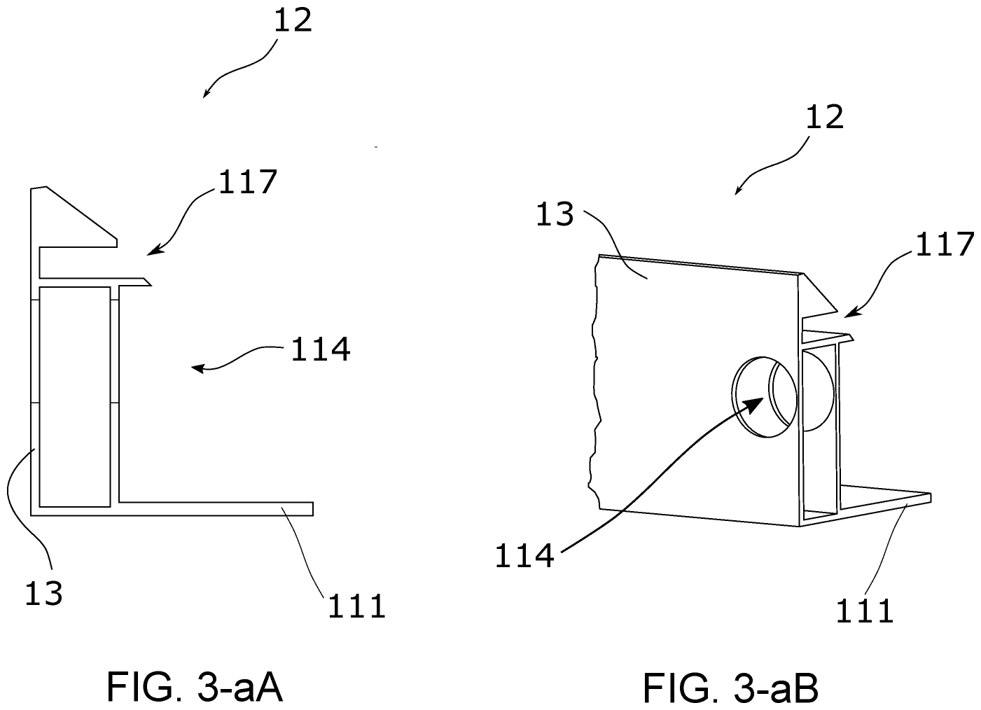

FIG. 3-AA and FIG. 3-aB depict views of a portion of an exemplary module frame 13 having weep hole 114. These figures show glass slot 117, which receives module substrate 116. FIG. 3-aB shows module side 13 in perspective.

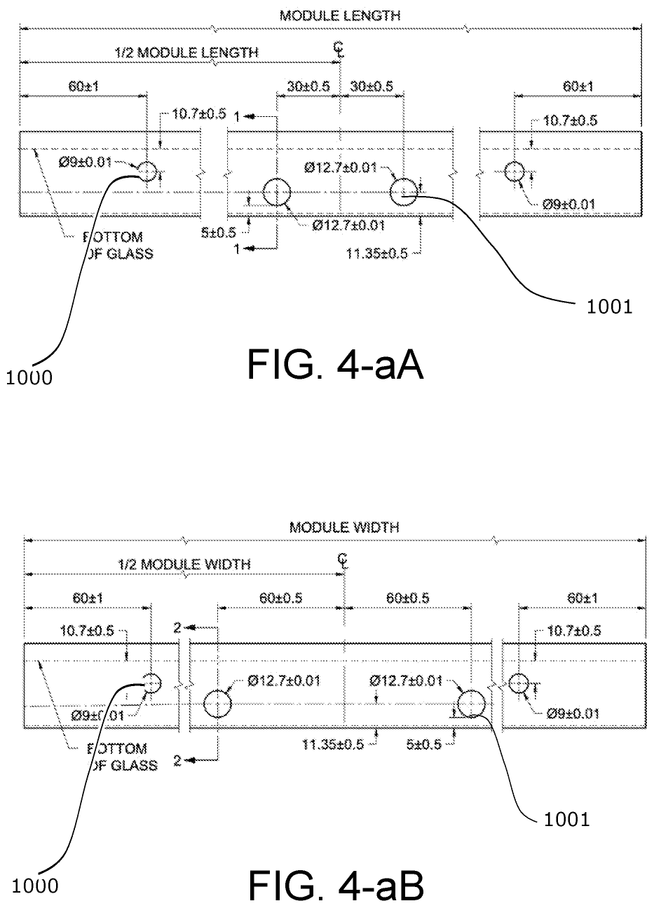

FIG. 4-aA shows an example of a module side 13 with a 9 mm weep hole 1000, located 60 mm from an end of module side 13 and 10.7 mm below the bottom of module substrate 116. FIG. 4-aB also shows fastening holes with a 12.7 mm diameter located 30 mm from the centerline of module side 13. The bottom edges of fastening holes are shown located 5 mm above the bottom edge of module side 13.

FIG. 4-aB shows an example of a module side 13 with a 9 mm weep hole 1000, located 60 mm from an end of module side 13 and 10.7 mm below the bottom of module substrate 116. FIG. 4-aB also shows fastening holes with a 12.7 mm diameter located 60 mm from the centerline of module side 13. The bottom edges of fastening holes are shown located 5 mm above the bottom edge of module side 13.

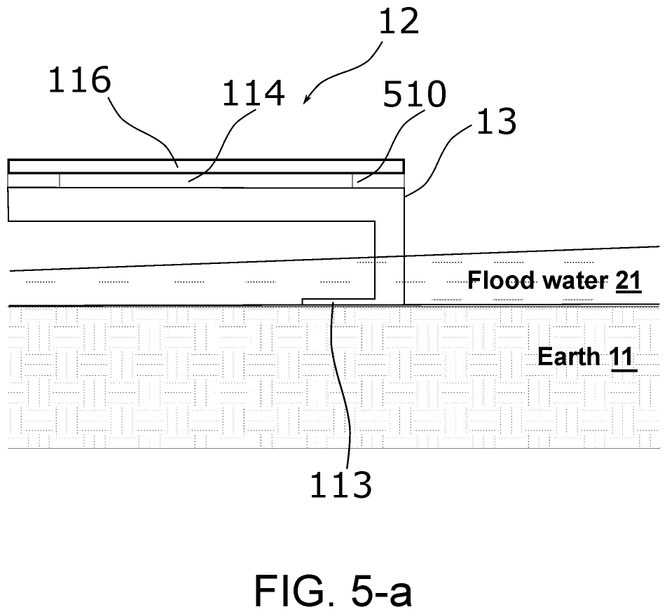

FIG. 5-a depicts module 12 with module side 13 and module base 113 sitting on Earth 11, similarly to FIG. 1-a. Module substrate 116 attaches to the frame of module 12 through spacers 510. These spacers can be blocks of material similar to the material of the frame or can be an adhesive. Spacers 510 raise substrate 116 up from the frame, creating weep holes 114. Otherwise, this version behaves as the versions described above.

What is claimed is:

1. A method comprising:
arranging 250 PV modules in any array on the ground;
electrically connecting the modules into strings;
connecting the strings to inverters;
connecting the inverters to an electrical grid;
generating electricity using the array;
and
supplying the electricity to a utility grid,
wherein greater than 90% of the modules have a weep hole.

2. The method of claim 1 wherein greater than 40% of the modules have two weep holes.

3. The method of claim 2 wherein greater than 40% of the modules further comprise a fastening hole.

4. The method of claim 3 wherein at least a first weep hole is located on a first module side and the fastening hole penetrates the first module side.

5. The method of claim 4 wherein the first weep hole is located on the first module side.

6. The method of claim 5 further comprising mechanically connecting the modules with a mesh cable system in at least a first direction using at least one fastening hole in the first module side.

7. The method of claim 6 wherein the mesh cable system connects the modules in at least a first direction using at least two fastening holes.

8. The method of claim 7 wherein the module further comprises a ground hole.

9. The method of claim 8 wherein at least a second weep hole is located on the first module side.

10. The method of claim 9 wherein at least a third weep hole is located on a second module side.

11. The method of claim 10 wherein at least a fourth weep hole is located on the second module side.

12. The method of claim 11 wherein the first module side is opposite the second module side.

13. The method of claim 12 wherein at least a fifth weep hole is located on a third module side.

14. The method of claim 13 wherein at least a sixth weep hole is located on the third module side.

15. The method of claim 14 wherein at least seventh and eighth weep holes are located on a fourth module side.

16. The method of claim 15 wherein the third module side is opposite the fourth module side.

17. The method of claim 16 wherein at least one weep hole is located on the module side within 0-250, 10-200, 10-150, 10-100, 20-250, 20-200, 20-150, 20-100, 30-500, 50-250, or 75-150 mm of a corner.

18. The method of claim 17 wherein at least four weep holes are located on the module sides within 0-250, 10-200, 10-150, 10-100, 20-250, 20-200, 20-150, 20-100, 30-500, 50-250, or 75-150 mm of a corner.

19. The method of claim 18 wherein the mesh cable system connects the modules in at least a second direction using at least one fastening hole in a module side.
